(19) United States
(12) Patent Application Publication
(10) Pub. No.: US 2004/0200102 A1
(43) Pub. Date: Oct. 14, 2004

(54) Symbol illuminator of game machine

(76) Inventor: Fumio Inoue, Tokyo (JP)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/436,106

(22) Filed: May 13, 2003

(30) Foreign Application Priority Data
Apr. 14, 2003 (JP) P2003-109059

(51) Int. Cl. G09F 13/16

(52) U.S. Cl. 40/582

(57) ABSTRACT

A symbol illuminator of game machines includes a wheel member having symbols at an outer circumferential surface thereof; a casing for the wheel member attached a printed circuit board having a plurality of illuminants; and a reflective frame member having enclosure walls expanding outwardly to a forward direction from a central part thereof, having a plurality of windows set the illuminants thereinto, characterized in that the illuminants arranged so as to project inside a center part of the reflective frame member; and a projection part, having a reflective face, reflecting the light emitted by the illuminants toward at least the symbol from the inner side of the wheel member so that it can irradiate a reflex of a reflective frame member equally without spots to the symbol of wheel member and can reduce the number of the parts.

### BACKGROUND OF THE INVENTION

The present invention relates to a symbol illuminator of game machines such as pachinko game machines, game machines with wheel member and game machines with wheel reel. Especially, this invention is suited for the game machines provided the symbols around the wheel member.

An applicant indicates a (1) Unexamined patent application publication No. 9-320534 (P1997-320534A) as an indication duty of reference information of a prior art. In the reflective frame member indicated in FIG. 5 of the Official Gazette, an enclosure wall (upper, lower, right and left walls) extends forwardly from the central part formed in the shape of a vertical wall. A printed circuit board is fixed to the left wall of the enclosure wall, and two lamps locate inside the enclosure wall through sockets. The lighting part of the embodiment consists basically of the printed circuit board which has a plurality of lamps and a reflective frame member formed in the shape of a tray so that the light emitted by the lamps reflects in the inner surface of the enclosure wall, and the light is irradiated to the symbol of the wheel member. However, since the light emitted by the lamps reflects only in the inner surface of the enclosure wall in this embodiment, it cannot have enough the diffusion efficiency. Moreover, since the lamps project from the inner wall of the left wall so that it parallels the inner wall located at a central part, the direct light of the lamp is too strong, and the symbol is irradiated in spot.

The applicant also indicates an Unexamined patent application publication No. 11-155998. The reflective frame member indicated in FIG. 4 of the Official Gazette consists of two or more reflective boards. Namely, the first reflective board with U-letter shape, the second reflective board with L-letter shape and the third reflective board are arranged individually at outer portion of the wheel member formed in the shape of a rotation reel. In this embodiment, although the reflex of the reflective member can be irradiated equally to the symbol without a spot, there are too many reflective boards and the combination of each part is not easy.

The applicant also indicates an Unexamined patent application publication No. 2003-29674. In this embodiment, the printed circuit board with two or more light emitting diodes is attached behind the enclosure wall, and the light emitting diodes are arranged into the enclosure wall. The light emitted by the light emitting diodes reflects the inner wall surface of the enclosure wall of and is irradiated from the inside of the wheel member to the symbol. In this embodiment, there is the same problem as (1) so that it is necessary to provide a light diffusion sheet between the light emitting diode and a display sheet.

### SUMMARY OF THE INVENTION

Accordingly, it is an object of the invention to provide a symbol illuminator of a game machine that can irradiate a reflex of a reflective frame member equally without spots (not spot) to the symbol of wheel member that is located in the display window of a game machine. In other wards, the light from a plurality of illuminants is diffused in all the directions using the outer wall reflective face of the projection part located in the middle of the reflective face of an enclosure wall and an illuminant, and the visibility of a player is improved (the first embodiment). It is another object of the invention to provide a symbol illuminator of a game machine that can reduce the number of the parts, and a printed circuit board and a reflective frame member can be attached fixedly and stably (not crank) (the first embodiment). It is further object of the invention to provide a symbol illuminator of a game machine that a printed circuit board and a reflective frame member can connect easily (the second embodiment).

The word of “enclosure wall” has a concept of a central part and includes a surrounding wall of a cone-shaped hollow, a bugle-shaped surrounding wall, polygonal surrounding wall having top, bottom, left and right walls and a surrounding wall of an ellipse shape. Moreover, the word of “central part” includes a perpendicular wall and a slightly carved wall. Moreover, the word of “projection part” includes a part which extends to an opening edge of the enclosure wall from the central part thereof and includes the partition wall with a reflective face corresponds to each illuminant. The word of “projection part formed in the shape of the partition wall” means to form widely the reflective face with a mountain form in cross section, unlike the partition wall provided in order to prevent to interfere the light emitted from each illuminant. Therefore, when the size of the height scales down and the projection part is not extended to the end portion of the enclosure wall, for example, the light reflected by the projection part of the shape of the partition wall and the light which is not influenced by the projection part are generated. In addition, the central part of the enclosure wall is formed an inclination wall or horizontal wall, depending on the arrangement of the reflective member.

### BRIEF DESCRIPTION OF THE DRAWINGS

FIGS. 1 to 11 show the explanation views of a first embodiment of the present invention. FIGS. 12 to 14 show the explanation views of a second embodiment of the present invention.

FIG. 1 is a schematic front view of a game machine that is applicable in this invention;

FIG. 2 is a exploded perspective view showing a first embodiment of the present invention;

FIG. 3 is an explanation view showing a relationship between a revolving member and the other members;

FIG. 4 is a perspective view of a reflecting frame member;

FIG. 5 is a front view of a reflecting frame member;

FIG. 6 is a schematic cross sectional view taken along the line 6-6 of FIG. 5;

FIG. 7 is a schematic cross sectional view taken along the line 7-7 of FIG. 5;

FIG. 8 is a schematic cross sectional view taken along the line 7-7 of FIG. 5;

FIG. 9 is a schematic explanation view showing the way in which a printed circuit board is connected to a reflecting frame member;

FIG. 10 is an explanation view showing an action of irradiation;

FIG. 11 is a variation including a first embodiment (four illuminants);

FIG. 12 is an exploded perspective view showing a second embodiment of the present invention;

FIG. 13 is an explanation view in front; and

FIG. 14 is a schematic cross sectional view showing the way in which a printed circuit board is connected to a reflecting frame member.

### DETAILED DESCRIPTION OF THE PREFERRED EMBODIMENTS

Preferred embodiments of the present invention are described in more detail below with reference to the accompanying drawings.

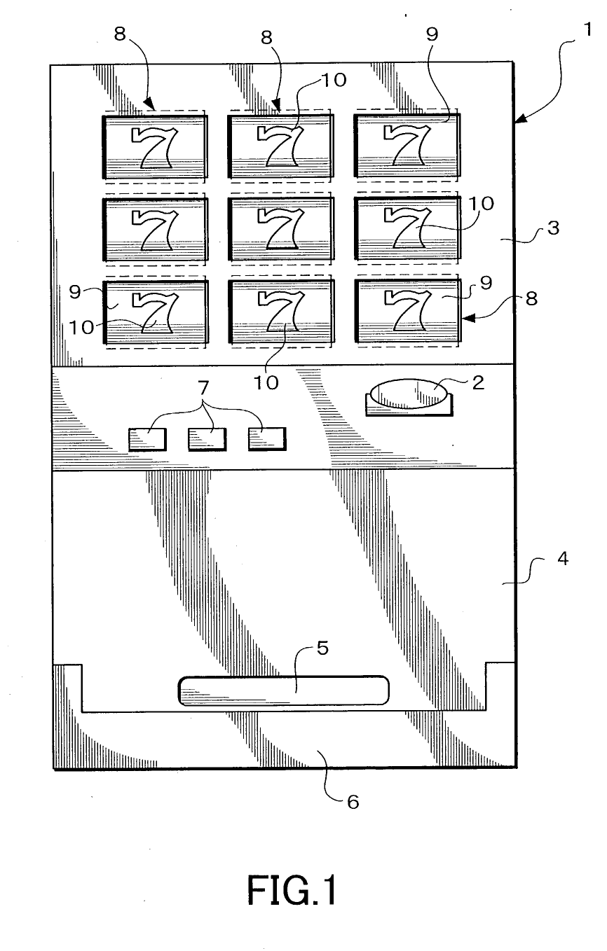

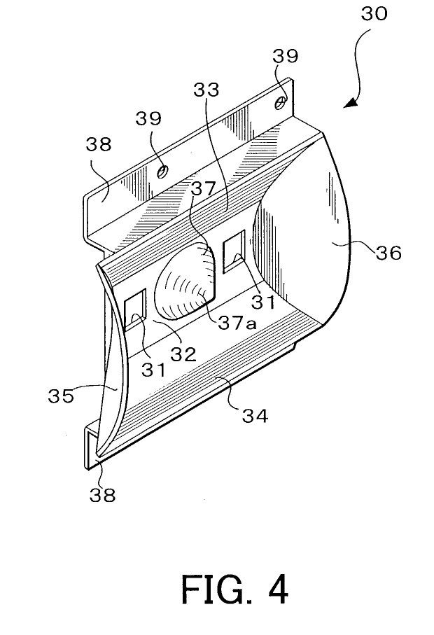

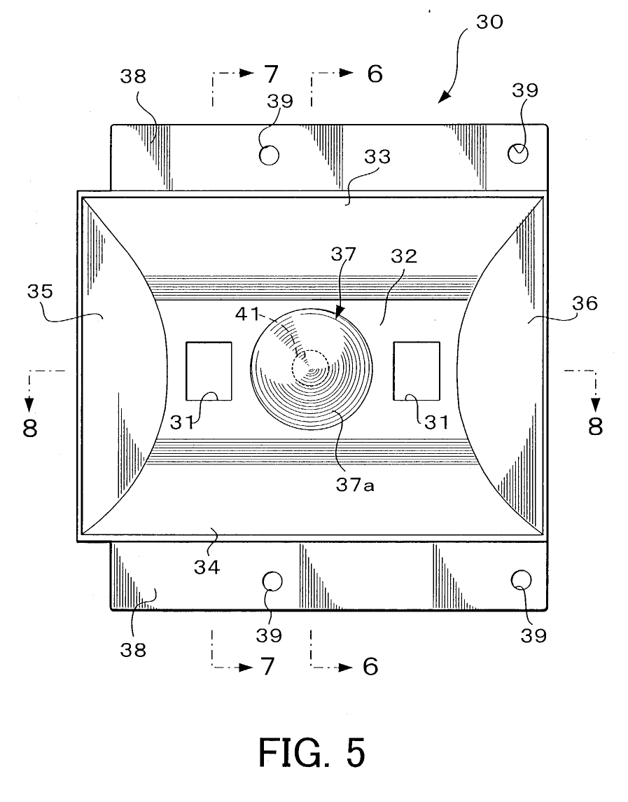

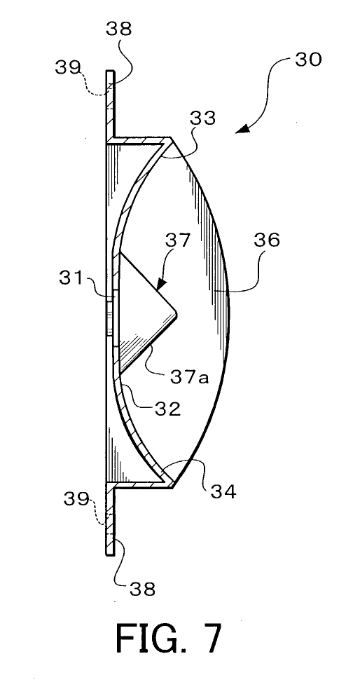

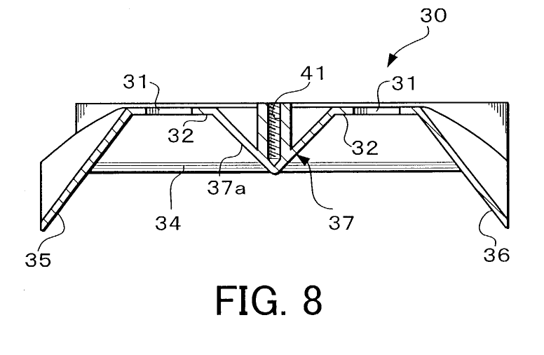

An understanding of the present invention may be best gained by reference to FIGS. 1-10.

FIG. 1 shows a schematic front view of a game machine (such as, for example slot machine) which is applicable in the present invention.

The appearance of the game machine 1 is explained briefly. The numeral 2 shows a medal slot provided at a central portion thereof; numeral 3 shows an upper panel provided at an upper portion of the medal slot 2; numeral 4 shows a lower panel provided at a lower portion of the medal slot 2; numeral 5 shows a medal return; and numeral 6 shows a medal receivable part. The numeral 7 shows means for operating with touching, provided at the central portion thereof. A plurality (nine pieces, for example) of symbols 10 (numbers, figures etc.) of a wheel member 9 can be watched through a display window 8 of the upper panel 3. When the operation means 7 is operated, the wheel member 9 rotates and stops via a control means, a drive motor and the like which are not be illustrated.

In addition, each form of the display window 8 is not limited to a quadrangle. For example, any shape of the display window 8 such as a hexagon shape, an ellipse shape and circular shape may be formed. Moreover, the style of the symbol also may change corresponding to each size and form of the display window 8.

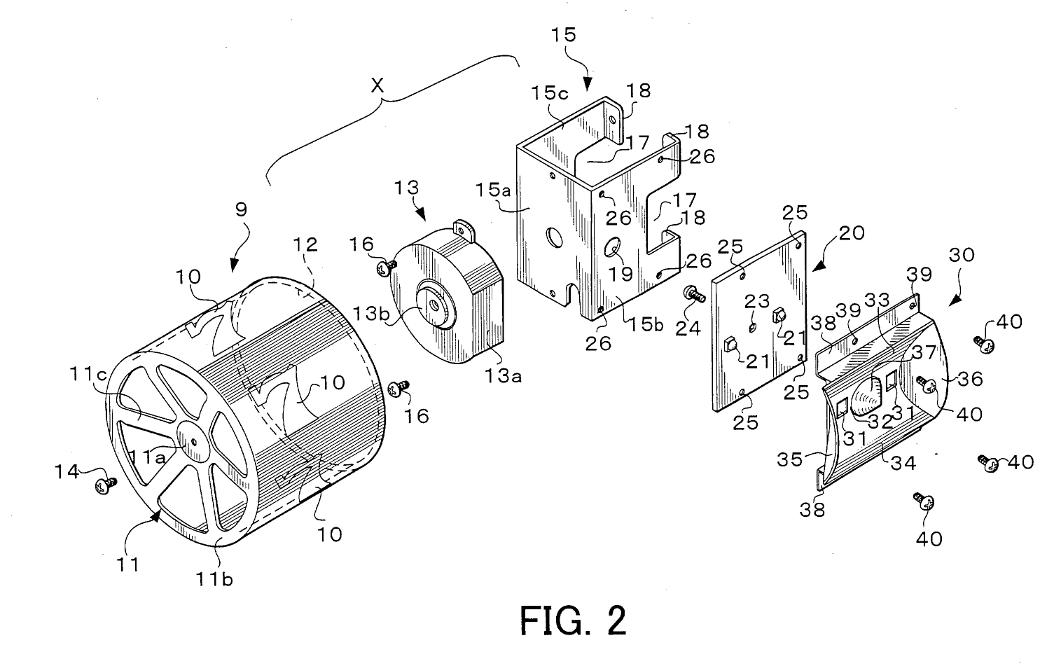

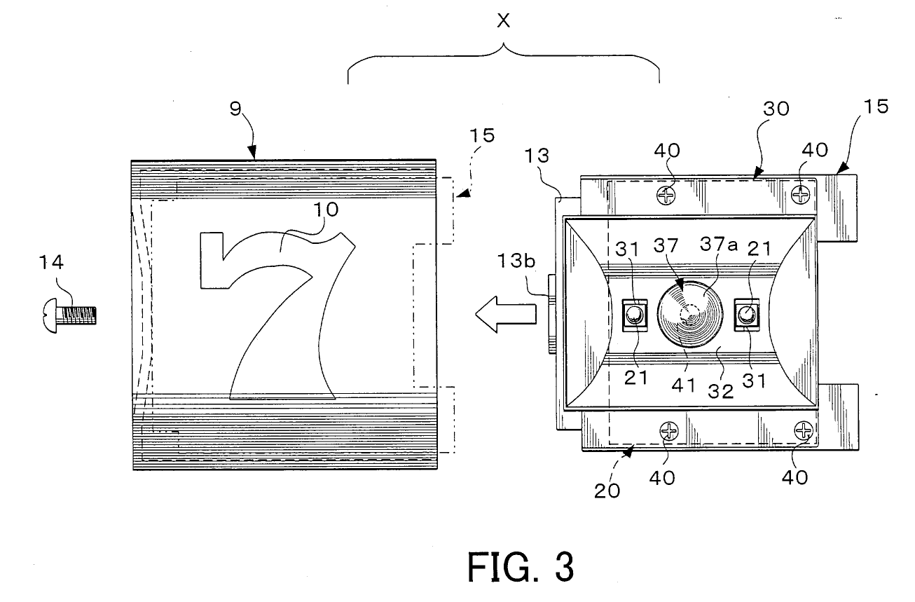

As shown in FIG. 2 and FIG. 3, the main components of the present invention are installed in the wheel member 9 arranged at each display window 8 of the game machine 1. The symbol illuminator X of the present invention is explained. The numeral 9 shows the wheel member 9 formed in the shape of a pipe, having symbols 10 at an outer circumferential surface thereof. An attachment part 11 for a drive motor is attached at an end opening of the wheel member 9. The attachment part 11 includes a center part 11a formed shape of a circle, having the singular number or two or more screw holes; a ring part 11b which is located at an outer portion thereof; and a plurality of arms 11c which connect radially with the center part 11a and ring part 11b. Another end portion of the wheel member 9 is formed an opening 12 so as to install of a frame, drive motor, reflective frame member and the like.

The numeral 13 shows a drive motor (stepping motor, for example). The drive motor 13 has a shaft 13b in the central part of a case 13a. The shaft 13b is associated with the wheel member 9 via the attachment part 11 formed in the shape of a frame and a first mounting screw 14. Therefore, when the shaft 13b rotates, the wheel member 9 is also rotated.

The numeral 15 shows a casing for the wheel member. The drive motor 13 is provided along with an outer wall of one of side walls 15a of the casing 15 through the projection part the upper and lower portions of the case 13a and a plurality of second mounting screws 16. Therefore, the wheel member 9 formed in the shape of a reel is indirectly fixed to the casing 15 through the drive motor 13. Also the casing 15 includes an axle hole, a screw hole, a cutting part for wiring, a fit hole for mounting screw and the like.

When the left wall 15a of the casing 15 shown in FIG. 2 is explained basically, the upper and lower portions of the casing 15 are opened widely. The numeral 15b shows a front wall that intersects perpendicularly with the left wall 15a. The front wall 15b has a cutting part 17 formed in the shape of a rectangle having from the right end portion thereof to a portion adjacent a central portion thereof. Moreover, the upper and lower portions of the right end of the front wall 15b are provided end plates 18 and 18 which cross inside thereof. Moreover, the fit hole 19 for mounting screw mentioned later is formed at the portion adjacent the central part of the front wall 15b.

In addition, the numeral 15c shows a back wall that intersects perpendicularly with the left wall 15a. The back wall 15c locates opposite to the front wall 15b. Since the back wall 15c is formed as well as the front wall 15b, the same marks are given to the cutting part or the like. The casing 15 is fixed to a support member into the game machine 1 through the end plates 18 and 18.

The numeral 20 shows a printed circuit board having a plurality of illuminants 21 and 21 (two illuminants, for example) attached to a center portion thereof. The illuminants 21 and 21 are arranged at a predetermined space at a horizontal state, and they are attached offset slightly at a portion adjacent the left end part of the printed circuit board. The printed circuit board 20 is formed in the shape of a quadrangle and formed the same size substantially of the front wall 15b of the casing 15.

The printed circuit board 20 includes a plurality of small holes, that is, the numeral 23 shows a through hole formed at a middle portion of the illuminants 21 and 21. The through hole 23 is inserted a third mounting screw 24 through the fit hole 19 from an inner wall of the front wall 15b of the casing 15. The third mounting screw 24 is screwed into a screwed hole 41 of a projection part 37 for reflection of a reflective frame member 30.

Therefore, the printed circuit board 20 is fixed to the reflective frame member 30 via the third mounting screw 24. In addition, the numeral 25 shows through holes formed at a predetermined interval at the upper and lower ends of the printed circuit board 20. Four through holes 25 correspond to screw holes 26 formed at the upper and lower ends of the front wall 15b of the casing 15 and are provided offset at portions adjacent the right end part of the printed circuit board 20.

The numeral 30 shows the reflective frame member and has a plurality of small windows 31 and 31 that are installed the illuminants 21 and 21 thereinto. The enclosure walls 33, 34, 35 and 36 provided at an upper, lower, right and left portions expand outwardly to a forward direction from the central part 32 formed in the shape of a vertical wall. In this embodiment, the reflective frame member 30 is formed a vertical wall with a tray shape at the center part 32 thereof.

Moreover, an opening edge of the reflective frame member 30 is formed in the shape of a rectangle, and the right and left walls 35 and 36 of the equivalent to the parts of the enclosure walls are curved outwardly. The word of “enclosure wall” includes a surrounding wall of a cone-shaped hollow, a bugle-shaped surrounding wall, polygonal surrounding wall having top, bottom, left and right walls, a surrounding wall of an ellipse shape such as a bank for running of a bicycle race.

The enclosure walls 33, 34, 35 and 36 are curved at a part or all parts thereof in order to raise reflective efficiency. Furthermore, oblong attachment plates 38 and 38 are projected in the outer wall of the upper and lower walls 33 and 34.

The numeral 39 shows a plurality of attachment holes which are formed at attachment plates 38 and 38 with angular L letter shape at a predetermined intervals. The attachment holes 39 correspond to the through hole 25 of the printed circuit board 20 and the screw holes 26 of the casing 15. The reflective frame member 30 is stably fixed to the casing 15 through the through holes 25, 26 and 39 and fourth mounting screw 40.

Therefore, the printed circuit board 20 is sandwiched between the front wall 15b of the casing 15 and the attachment plates 38 and 38 of the reflective frame member 30. When the printed circuit board 20 associates with the casing 15, two illuminants 21 and 21 jump out from the small windows 31 and 31 of the central part of the reflective frame member.

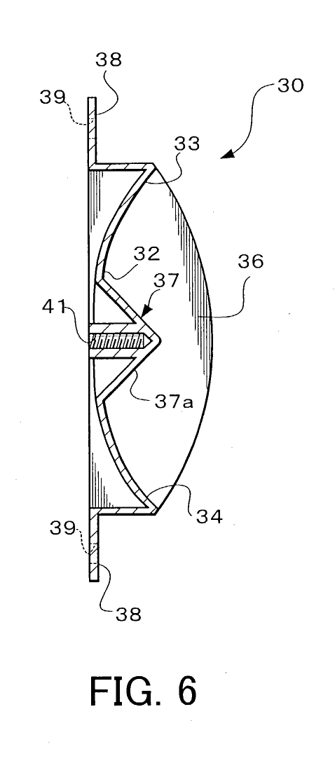

The numeral 37 shows the projection part that is installed between the illuminants 21 and 21, having a reflective face 37a formed in the shape of a cone or pyramid, reflecting the light emitted by the illuminants 21 and 21 toward the symbol 10 from the inner side of the wheel member 9. In this embodiment, the reflective face 37a is formed in the shape of the cone. As shown in FIG. 6, the projection part is formed in the shape of a mountain in cross section, and the screwed hole 41 in which is screwed the third mounting screw 24 is formed therein.

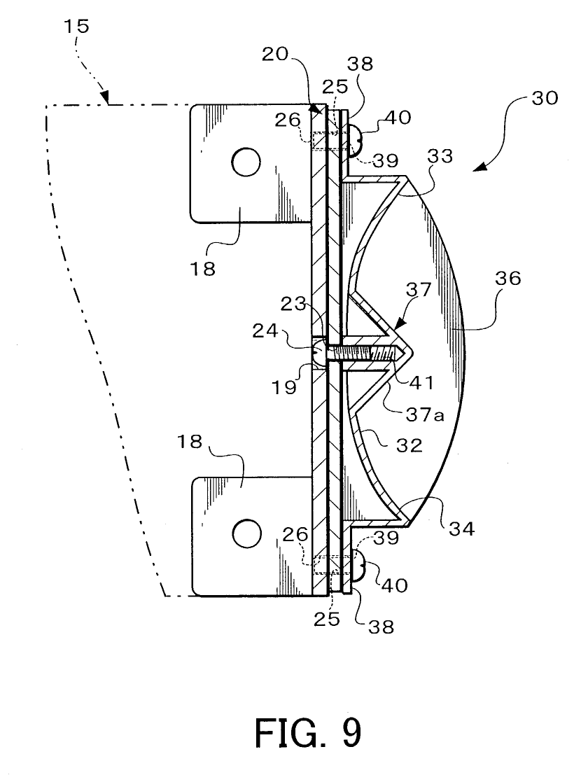

FIG. 9 is an explanation view showing the way in which the reflective frame member 30 is fixed to the casing 15. Since the reflective frame member 30 is fixed to the surface of a printed circuit board 20, the attachment hole 39 of the reflective frame member 30 is put upon the through hole 25 of the printed circuit board 20. The third mounting screw 24 is inserted into the through hole 23 located at the center part of the printed circuit board 20 and screwed into the screwed hole 41 of the reflective frame member 30. The printed circuit board 20 is associated with the reflective frame member 30 temporarily. The attachment hole 39 of the reflective frame member is put upon the screw hole 26, and the fourth mounting screw 40 is screwed into the screw hole 26.

After the printed circuit board 20 and the reflective frame member 30 are attached to the front wall 15b of the casing 15, the head of the third mounting screw 24 fits the fit hole 19 of the casing 15. Therefore, the third mounting screw 24 is not a drag. The printed circuit board 20 and the reflective frame member 30 are attached certainly to the casing 15.

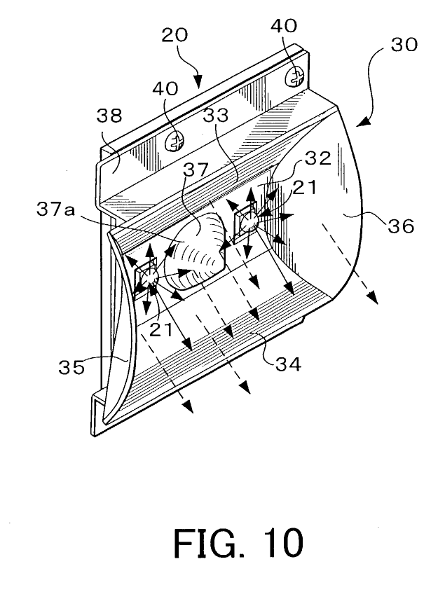

Next, FIG. 10 shows the explanation view of a relation between the reflective frame member 30 and the illuminant 21. The illuminant 21 is the Light Emitting Diode (LED) diffusing in the large range in this embodiment so that the light is emitted in all the directions by the short arrow, for example. The light emitted by the LED has the direct light (solid line arrow) directly irradiated to the symbol 10 of the wheel member 9 which is located in the display window of the game machine and the reflex (dotted line arrow) indirectly irradiated to the symbol 10 after reflecting in the outer wall 37a of the projection part 37 and the inner wall of the enclosure wall of the reflective frame member 30.

In this embodiment, the inner surfaces of the enclosure walls 33, 34, 35 and 36 are the reflective face. Moreover, the outer wall 37a of the projection part 37 is also the reflective face. The solid line arrow and dotted line arrow show as a matter of convenience. In the light emitted by the LED, the reflex is equally irradiated without spots (not spot) to one symbol 10 of the wheel member 9 which is located at the display window 8.

Although the wheel member 9 is formed in the shape of a reel, it is not limited such shape. The non-ended rotation belt that rotates through a plurality of guide rollers may be used. The central part of the reflective frame member 30 is formed the vertical wall, and it may be formed slightly curved shape. The projection part of the reflective frame member 30 is formed in the shape of the mountain in cross section.

The words of “mountain shape in cross section” means a shape of a reflective face of the outer wall having a function to diffuse the light emitted by the illuminants widely, including a simple conical shape in cross section, a pyramidal trapezoid shape in cross section, a semicircle ball shape in cross section, a spherical segment shape in cross section and the like.

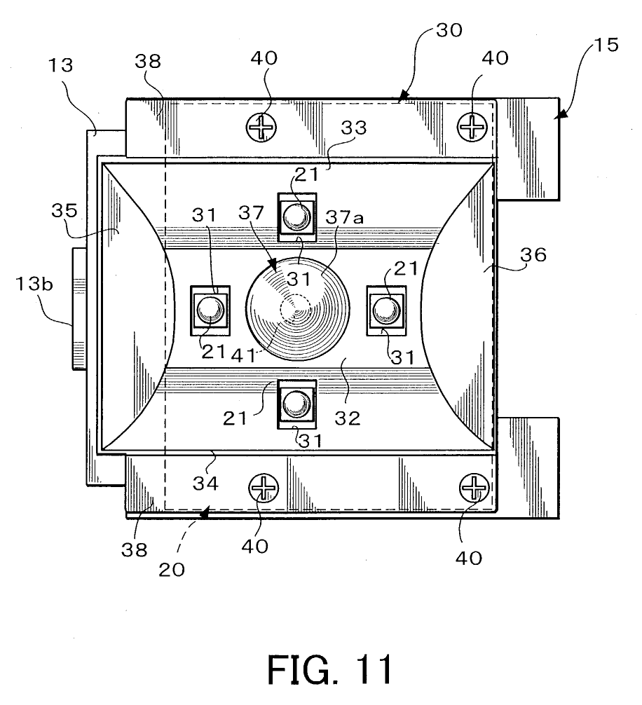

The projection part located in the middle of the illuminants may be used the plural number, halved types etc. Moreover, since the size (measure) of the projection part can be suitably set up in consideration of the form of the reflective face or enclosure wall, the intensity of the light emitted from the illuminant and the like, the size is also not limited. In brief, as shown in FIG. 11, the projection part 37 should just be in the plurality of the illuminants 21 (four pieces, for example). In the embodiment shown in FIG. 11, four illuminants 21 are arrange suitably at the printed circuit board 20, each illuminant 21 projects in the enclosure walls 33, 34, 35 and 36 from the small window 31A formed concentrically of the projection part 37 of the reflective frame member 30.

Moreover, at least some parts of the enclosure walls of the reflective frame member are curved outwardly or inwardly.

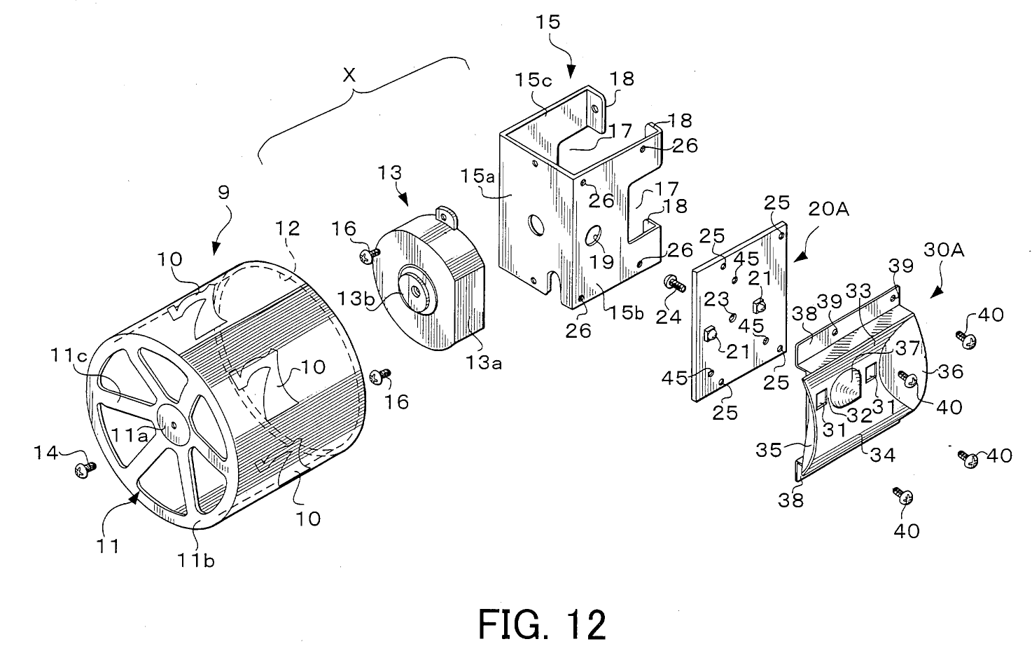

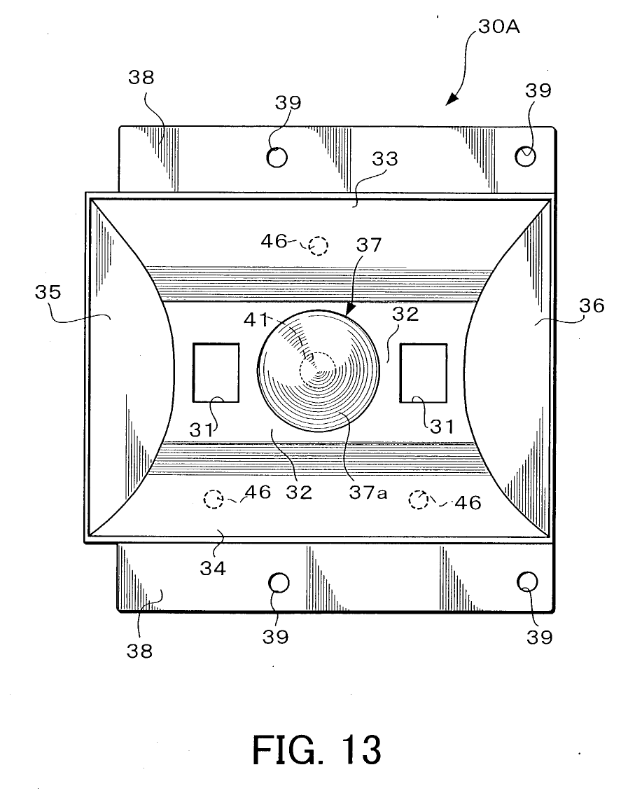

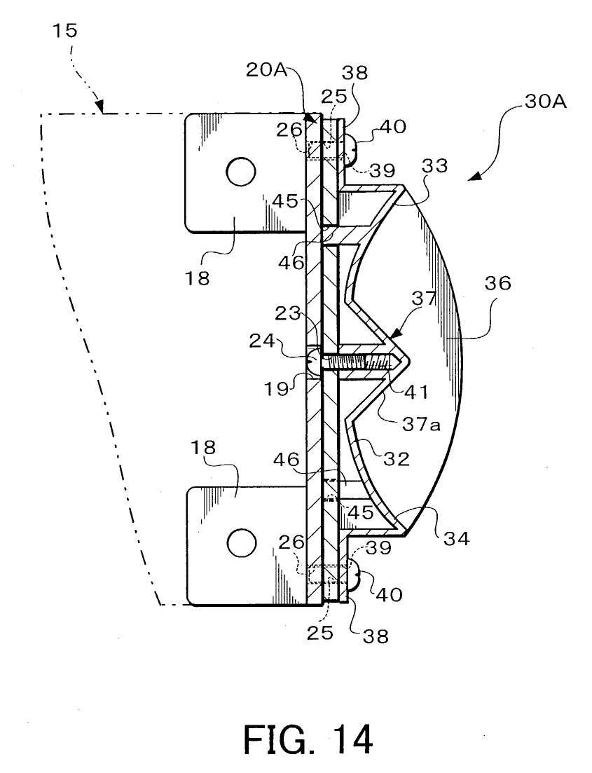

Other embodiments of the present invention will now be described with reference to FIGS. 12-14. In FIGS. 12-14, the same components as in the first embodiment described above with reference to FIGS. 12-14 are designated by the same reference numerals and therefore will not be further explained in great detail.

A second embodiment of the present invention is shown in FIGS. 12-14. It is distinguished from the first embodiment in that a printed circuit board 20A is connected to a reflective frame member 30A simply.

Then, a plurality of engaged parts 45 (engage hole, for example) for positioning are formed at a printed circuit board 20A, and a plurality of engage parts 46 (engage projection, for example) which engage with the engaged parts 45 are formed at a reverse-side of the reflective frame member 30A.

Therefore, in the second embodiment, when the engage parts 46 of the reflective frame member 30A are set in the engaged parts 45, the through hole 23 of the printed circuit board 20A corresponds to the screwed hole 41 of the projection part 37 of the reflective frame member 30A so that the printed circuit board 20A and reflective frame member 30A are connected easily through the third mounting screw 24.

As set forth above, the advantages of the invention are as follows:

(1) The symbol illuminator of game machines can irradiate a reflex of the reflective frame member equally without spots (not spot) to the symbol of the wheel member which is located at the display window of the game machine. Therefore, when a player looks at the symbols, he can look at wholly the symbol of a display window with blinking equally.

(2) The light emitted by the illuminants can be efficiently spread using the reflective face of one reflective frame member and one or more projection parts located at the middle of the illuminants Moreover, the number of the parts can be reduced, and the combination of each parts performs easy.

(3) In the second embodiment, the printed circuit board 20A is connected to the reflective frame member 30A simply.

What is claimed is:

1. A symbol illuminator of game machines comprising a wheel member having symbols at an outer circumferential surface thereof; a casing for the wheel member attached a printed circuit board having a plurality of illuminants; and a reflective frame member having enclosure walls expanding outwardly to a forward direction from a central part thereof, having a plurality of windows set the illuminants thereinto, characterized in that the illuminants arranged so as to project inside a center part of the reflective frame member; and a projection part, having a reflective face, reflecting the light emitted by the illuminants toward at least the symbol from the inner side of the wheel member.

2. A symbol illuminator of game machines according to claim 1, wherein the at least some parts of the enclosure walls of the reflective frame member are curved outwardly or inwardly.

3. A symbol illuminator of game machines according to claim 1, wherein the projection part is formed in the shape of a mountain in cross section, locating at a middle portion of light emitting diodes which project from the windows.

4. A symbol illuminator of game machines according to claim 1, wherein the outer circumferential surface of the projection part is formed in the shape of one of pyramid and cone.

5. A symbol illuminator of a game machines according to claim 1, wherein the projection part is formed in the shape of a partition wall, having the reflective faces which correspond to the illuminants.

6. A symbol illuminator of game machines according to claim 1, wherein the projection part further includes a screwed hole which corresponds to a through hole for a mounting screw formed at the printed circuit board, and the printed circuit board is associated with the reflective frame member via the mounting screw which screws into the through hole and screwed hole.

7. A symbol illuminator of game machines according to claim 1, wherein the enclosure wall includes a surrounding wall formed in the shape of one of a circle, an ellipse and a polygonal shape having top, bottom, left and right walls.

8. A symbol illuminator of game machines according to claim 1, wherein an opening edge of the reflective frame member is formed in the shape of a rectangle and a tray form, and attachment plates are provided and projected in the outer wall of an upper and lower walls thereof.

9. A symbol illuminator of game machines according to claim 1, wherein the printed circuit board is sandwiched between a front wall of the casing and the attachment plates of the reflective frame member via a plurality of mounting screws.

10. A symbol illuminator of game machines according to claim 1, further includes engaged parts for positioning are formed at the printed circuit board; and engage parts which engage with the engaged parts which are formed at a reverse-side of the reflective frame member.
